(19) United States
(12) Patent Application Publication
(10) Pub. No.: US 2021/0058243 A1
(43) Pub. Date: Feb. 25, 2021

(54) SYSTEM FOR STRUCTURING OBJECTS FOR OPERATION IN SOFTWARE ENVIRONMENTS AND METHODS FOR ITS IMPLEMENTATION

(71) Applicant: Valerii Starodubtsev, Novosibirsk (RU)

(72) Inventor: Valerii Starodubtsev, Novosibirsk (RU)

(21) Appl. No.: 17/043,864

(22) PCT Filed: Mar. 4, 2019
(86) PCT No.: PCT/RU2019/050023

§ 371 Date: Sep. 30, 2020

(30) Foreign Application Priority Data
Mar. 30, 2018 (RU) 2018111584

(51) Int. Cl. H04L 9/08; H04L 9/06; H04L 29/08; G06F 9/50; G06F 9/455; G06F 9/38

(52) U.S. Cl. CPC H04L 9/0852; H04L 9/0643; H04L 67/104; G06F 9/5044; G06F 2009/4557; G06F 9/45558; G06F 9/3836; H04L 2209/38; G06F 9/5055

(57) ABSTRACT

FIELD: information technology. SUBSTANCE: invention relates to means of structuring objects for operation in software environments. System comprises a software and hardware system for inputting and setting a task, configured to interact with an external software environment; software and hardware complex for generating a genesis smart asset of an object; smart-division hardware and software system; software and hardware system for interaction of smart assets. Methods describe operation of said system. EFFECT: wider range of technical means, which provide higher security and reduced vulnerability of program elements of interaction and functioning in software environments, including in a blockchain medium.

### FIELD OF TECHNOLOGY

The present invention relates to the field of information technology, to the organization of virtual space, management of virtual space, and can also be used in many fields of activity, including:
for systematization of object management;
structuring objects for working in software environments;
for organizing structural P2P interaction.

### PRIOR ART

Currently, there is an acute problem of implementing digital technologies in all spheres of activity, including the economy and management. New systems and software environments are being developed to meet these challenges. Distributed registry systems have come to the fore. One of the most advanced is the software environment—the Etherium blockchain network platform based on smart contracts.

This technology is young and not without disadvantages. This is also due to the state of the Blockchain infrastructure. There are problems such as scalability, lack of proper structuring and proper security.

The present invention is aimed at solving the above problems.

The application uses the following terms known from the state of the art.

An Overlay Network is a General case of a logical network that is created on top of another network. Nodes in an overlay network can be connected either by a physical connection or by a logical one, for which one or more corresponding routes from physical connections exist in the main network.

Peer-to-peer (P2P) network is an overlay computer network based on the equality of participants. Often there are no dedicated servers in such a network, and each peer is both a client and a server.

Ethereum—platform for creating decentralized online services based on blockchain (decentralized applications) based on smart contracts. Implemented as a single decentralized virtual machine.

A distributed registry is a dynamic form of media that is a database that is stored and updated independently by each participant (or node) in a large network consisting of software and hardware complexes.

Blockchain—a continuous sequential chain of blocks (linked list) built according to certain rules, containing information stored in a distributed database.

Blockchain environment—an integrated set of technical and software tools built on the distributed database algorithm and blocks, peer-blockchain, in which the interaction, functioning, processing and storing information.

Smart contract is an electronic algorithm that describes a set of conditions that trigger certain events in the real world or digital systems. Smart contracts require a decentralized environment that completely eliminates the human factor.

Software environment—an integrated set of technical and software tools, with the help of which the functioning and development of programs is carried out.

HSC—(hardware-software complex), can be either centralized or decentralized.

Scalability—in electronics and computer science, refers to the ability of a system, network, or process to cope with increased workload (increase its performance) when adding resources (usually hardware).

Consensus (lat.consensus-agreement, unanimity)—a method of resolving conflicts when making decisions, if there are no fundamental objections from the majority of interested parties; making a decision based on General agreement without voting, if no one opposes it, or if the opinion of a few dissenting participants is excluded.

Algorithm—a set of instructions, including programmable ones, describing the order of actions of the performer to achieve a certain result.

Structuring is a memorization strategy in which elements of the memorized information are linked on some mashin logical basis into integral groups.

Virtual machine (VM) is a software and/or hardware system that emulates the hardware of a particular platform.

Genesis smart asset—the main, basic, smart, electronic asset whose software code contains all the necessary and sufficient characteristics of the object specified in predefined units of measurement, as well as an electronic algorithm for its implementation in the software environment of the object structuring system and its further functioning.

Object structuring system environment is an integrated hardware and software complex consisting of a hardware part that allows the software component to function and a software part-a program written in the appropriate programming language with an interaction algorithm that allows the system elements to interact with each other, interact with external systems and get a programmable result.

Value is an distinctive definition of an object or subject that reflects all its value and characteristics, including the numerical characteristic of a variable or function.

Quantum entanglement—quantum mechanical phenomenon in which the quantum States of two or more objects are interdependent (for example, you can obtain a pair of photons entangled, and then if the measurement of the spin of the first particle the helicity is positive, the second helicity is always negative, and Vice versa).

Quantum cryptography is a method of protecting communications, preserving and protecting information based on the principles of quantum physics.

### DISCLOSURE OF INVENTION

The present invention solves a technical problem—creating an effective technology for structuring objects for functioning in software environments.

Technical result is an expansion of the Arsenal of tools, technologies and tools for structuring objects for functioning in software environments, including the blockchain environment. The technical result is also the automation of object structuring for functioning in software environments.

The technical result is also an increase in information security, reducing the vulnerability of structured objects, smart assets, elements and tools for interaction and functioning in software environments, including in the blockchain environment.

The technical problem of creating the claimed technology is solved by automating the structuring of objects for functioning in software environments by means of software and hardware complexes of the object structuring system, which provide:
forming, generating the Genesis smart asset of an object;
automated smart division of asset smart-genesis by means of a software algorithm into derivative smart assets, including asset smart—rights to the object, asset smart—capital of the object, smart asset of debit, smart asset of credit.

Specified technical results are achieved by means of hardware and software complexes of the object structuring system at the expense of:
hardware and software division of smart assets into smart assets that carry the value component and smart assets that carry the promise of rights to the value component, while protecting the value component of the object in a hardware and software way, this achieves the stated reduction in vulnerability;
hardware and software implementation of the corresponding smart program codes in software algorithms that restrict or completely prohibit interaction with the external environment, this also achieves the stated reduction in vulnerability;
preserving the necessary and sufficient information in the hardware and software environment of the object structuring system, including in the blockchain environment, including achieving a predetermined consensus, including using quantum cryptography and reading quantum entanglement, this achieves the stated increase in information security, including from unauthorized changes to information.

These technical results are achieved thanks to the system of structuring objects for functioning in software environments and methods of its implementation, which contain, at least:
hardware and software input complex that interacts with the external software environment using a predefined software algorithm, which performs the stage of entering information from the external environment, where it is received, accepted, including from the object owner registered in the object structuring system, necessary and sufficient information for the functioning of the object structuring system, including about the object, indicate and transmit the values set, including in predefined units of measurement, to the environment of the object structuring system, confirm the task of forming the asset smart-genesis of the object, transfer the received infodata to the stage of Genesis smart asset formation in the software environment of the object structuring system to the software and hardware complex for Genesis smart asset formation;
hardware and software of formation of the Genesis smart asset object that the step of forming the Genesis smart asset object, where you receive and accept an adapted software environment for system structuring object infodata generated at the stage of information input from the external environment, a computer-readable Genesis smart asset of the object is formed by means of a software algorithm, used in this case, including the values used in predefined units of measurement that characterize the object and the smart asset, transfer the infodata generated by the software algorithm to the stage of division of the Genesis smart asset to the software and hardware complex of division of the Genesis smart asset, save the received information in the object structuring software environment, save the received information in an external software environment, including in a peer-to-peer blockchain environment;
hardware and software division complex that performs the division stage of the Genesis smart asset of an object on which, take information about the Genesis smart asset and divide by means of a software division algorithm, the Genesis smart asset of the object, at least on the machine-readable smart asset of the right to the object and on the machine-readable smart asset of the object's capital, form a machine-readable smart asset of the object's rights by means of a software algorithm and machine-readable smart asset of the object's capital, fixed by means of a software algorithm in the smart asset of the right information that this smart asset bears an intangible right of the first level arising from the birth of the object or subject, fixed by means of a software algorithm in a smart capital asset information that this smart asset shall be financially eligible on capital object, which occurs as a result of division of rights over the object by means of a software algorithm for dividing Genesis-smart asset and smart introduction to the capital asset value characteristics, fixed by means of a software algorithm in the smart asset of rights and smart asset of capital the values specified in predefined units of measurement that characterize each smart asset, respectively, setting the algorithm for interaction with other stages using the pre-installed program, transfer the received information to the stage of interaction of smart assets to the hardware and software complex of interaction of smart assets, save the received information in the software environment for structuring objects, preserve the received information in an external software environment, including a peer-to-peer blockchain environment;
hardware and software interaction complex that performs the smart asset interaction stage, where interaction is established according to a preset algorithm between smart assets for receiving and/or transmitting relevant information from the smart asset or to the smart asset, enter the necessary and sufficient information into the pre-installed software algorithm for interaction of the corresponding smart asset and/or smart assets with the software algorithm of the external software environment in accordance with the pre-installed interaction program, interact with the external software environment by means of a pre-installed interaction algorithm for receiving and/or transmitting relevant information from the external software environment and/or to the external software environment, including to and from the blockchain environment, preserve the received information in the object structuring software environment, preserve the received information in the external software environment, including in the blockchain environment, including with the achievement of a predefined consensus, including using quantum cryptography and reading quantum entanglement.

In some embodiments, technical results are achieved:
as a result of dividing the derivative smart asset, including the smart asset of the right to the object and the smart asset of the object's capital into the debit and credit smart assets that make up them, by means of a hardware-software complex;
setting the program code to protect the absolute value component of the right contained in the corresponding smart asset, indicated in the algorithm in predefined units of measurement;
settings in the program code of the relative value component of the right contained in the corresponding smart asset, indicated in the algorithm of the corresponding smart asset in predefined units of measurement, by means of which, among other things, interact with the algorithm of the external software environment.

In some embodiments, technical results are achieved by entering at any stage in the program algorithm of interaction of any smart asset a programmatically installed and/or programmatically removed security code and/or blocking from interaction with the external software environment.

In some embodiments, the implementation of the technical results achieved by the step of forming the external software environments, which through hardware and software complex external environment shape the software environment of functioning of system of structuring objects, including the blockchain environment, establish the interaction of the software environment of the system structuring of objects with the software operating environment that is external to the software environment of system of structuring objects.

In some embodiments, technical results are achieved through the access stage, in which, by means of a hardware-software access complex there occurs:
registration the rightholder of the object, including as a user of a software access algorithm (program), including the environment of the object structuring system, the external environment for the functioning of smart assets, including the blockchain environment;
transferring the rights and access keys to manage smart assets, including the values specified in these smart assets, to the registered owner of the object;
providing a registered user access to the software environment of the object structuring system, including the blockchain environment, using, among other things, reaching a predefined consensus, including using quantum cryptography and reading quantum entanglement.

In some embodiments, technical results are achieved at the expense of the transaction formation stage, in which the hardware and software complex of transaction formation interact with the hardware and software complex of smart asset interaction and execute:
generation a software algorithm for transactions between software environments, including transactions of values specified in predefined units in smart assets;
P2P interaction;
transactions according to the generated software algorithm;
saving the received information in the object structuring software environment;
saving the received information in an external software environment, including the blockchain environment, including with use the achievement of a predefined consensus, including the use of quantum cryptography and reading quantum entanglement.

### BRIEF DESCRIPTION OF DRAWINGS

Brief description of system options and methods for carrying out the invention with reference to the accompanying drawings.

The features and advantages of the present invention will become apparent from the following detailed description of the invention and the accompanying drawings, in which:

FIG. 1—a block diagram of the system illustrating the interaction of hardware and software complexes of the object structuring environment with each other, including with using the blockchain environment.

FIG. 2—a block diagram of the system illustrating the operation of a software and hardware division complex that divides smart assets of rights and capital into derivative smart assets of debit and of credit, respectively.

FIG. 3—a block diagram of the system illustrating a variant of the interaction of software and hardware complexes of the environment for structuring objects with the external environment, including the blockchain environment.

FIG. 4—a block diagram illustrating the stages of the method for structuring objects for functioning in software environments.

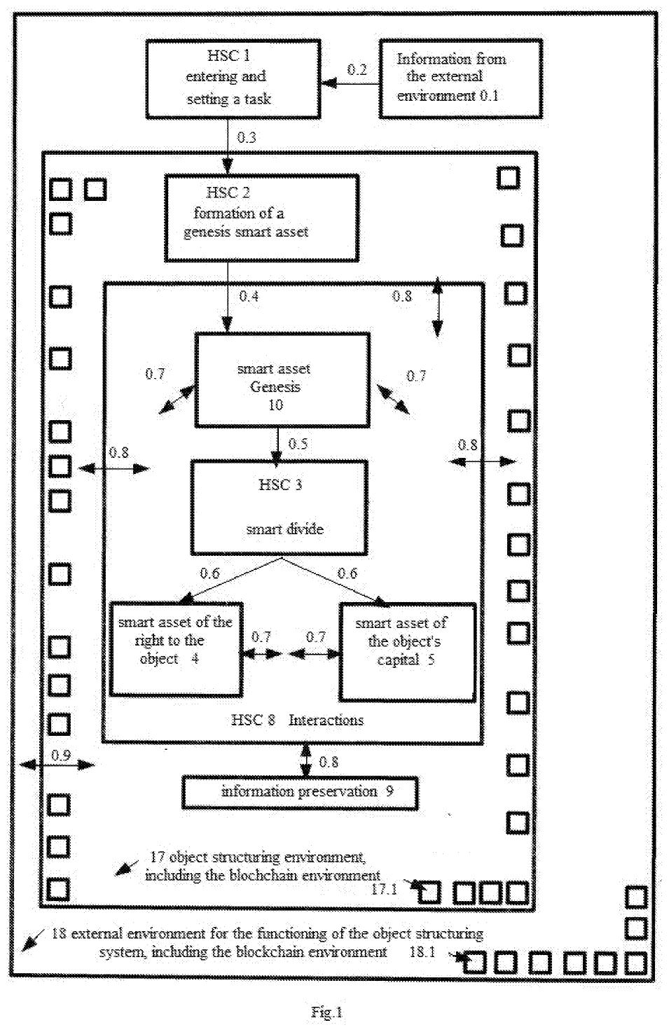

FIG. 1—illustrates the block diagram of a variant of interaction between hardware and software complex environments for structuring objects among themselves, including using the blockchain environment.

With reference to FIG. 1, the system variant contains: a hardware and software complex for entering and setting the task H-SC 1, which performs the stage 0.2 of entering information 0.1 from the external environment and setting the task 0.3 H-SC 2;

H-SC 2 for generating the Genesis smart asset of an object that performs stage 0.4 for generating the Genesis smart asset of an object 10 and transmits 0.5 information to H-SC 3;

H-SC 3 performing stage 0.6 of dividing the Genesis smart asset of object 10 into the smart asset of the right to object 4 and the smart asset of the capital of object 5;

H-SC 8 interaction of smart assets performing stage 0.7 interaction of smart assets 10, 4, 5 among themselves, interaction 0.8 with the environment of the object structuring system 17, including interaction 0.8 with the blockchain environment 17.1, information storage 9, interaction 0.9 with the external environment 18, including interaction 0.9 with the blockchain environment 18.1.

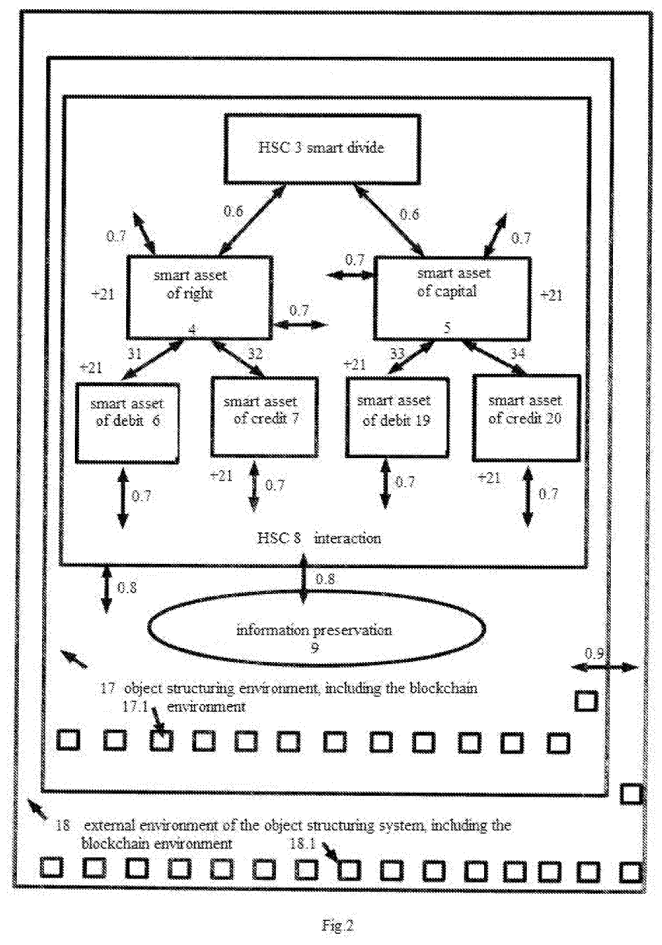

FIG. 2—illustrates the block diagram of a variant of the functioning H-SC 3, with reference to FIG. 2, a variant of the division system includes:

H-SC 3, performing the division stage 0.6, including the division of 31.32 smart assets of the right to object 4 and the division of 33.34 smart assets of the capital of object 5 into derivative smart assets of debit 6.19 and smart assets of credit 7.20, respectively;

H-SC 8 interactions smart assets, carrying out phase 0.7 interaction smart assets 4, 5, 6, 7, 19, 20, together, interact 0.8 with the environment structuring system of objects 17, including blockchain environment 17.1, store information 9, 0.9 of interaction with the external environment 18, including interaction with the blockchain 0.9 environment 18.1. In this case H-SC 8 sets the code protect +21 on any smart asset and/or smart assets, limiting the interaction with the external environment.

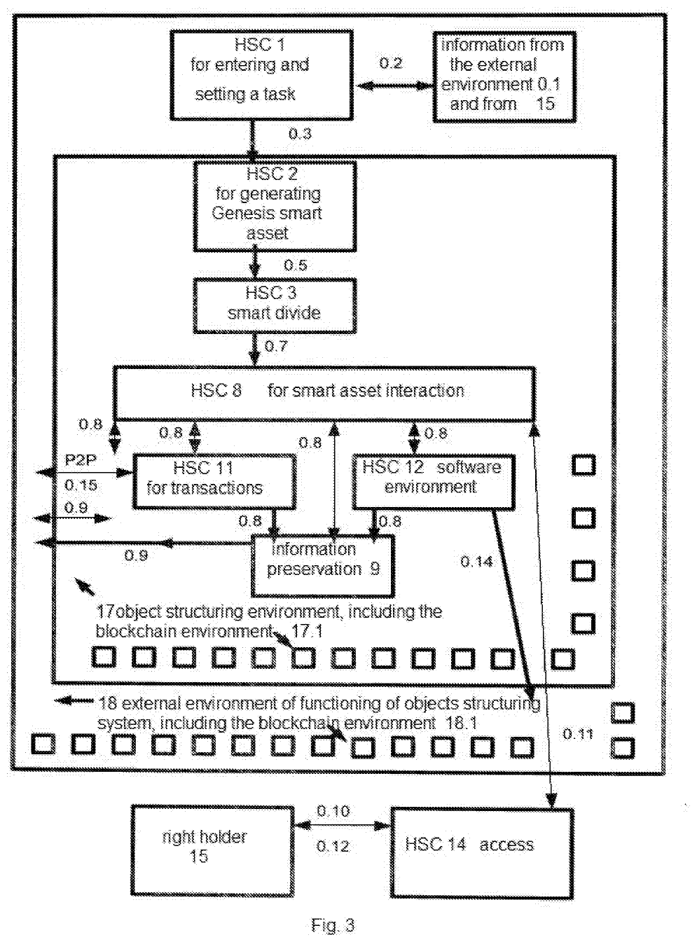

FIG. 3—illustrates the block diagram of a variant of interaction of hardware and software complexes of the object structuring environment with the external environment, including the blockchain environment. With reference to FIG. 3, the system variant contains:

H-SC 1 for entering and setting the task, performing the stage 0.2 for entering information 0.1 from the external environment and rightholder 15, and setting the task 0.3 H-SC 2;

H-SC 2 of the object's Genesis smart asset formation, performing the stage of the object's Genesis smart asset formation and transmitting 0.5 information to H-SC 3; H-SC 3 performing the stage of dividing the object's Genesis smart asset into derived smart assets and interacting 0.7 with H-SC 8;

H-SC 8 interactions smart assets, those interactions smart assets among themselves, interact 0.8 with H-SC 11 transactions, interact 0.8 with H-SC 12 environment, interact 0.8 with H-SC 14 access; 0.8 interaction with the environment structuring system of objects 17, including interaction with the 0.8 blockchain environment 17.1, 0.8 interactions for saving information 9; 0.9 interaction through the medium 17, 17.1 with the external environment 18, including the interaction of 0.9 through the medium 17, 17.1 with the blockchain environment 18.1.

H-SC 14 access, that performs the access stage 0.11 in the H-SC 8 of the object structuring environment 17, the registered 0.10 of the object's rightholder 15, and the interaction 0.12 with the registered rightholder 15;

H-SC environment 12, performing stage 0.14 of the formation of the external software environment for functioning 18, including the blockchain environment 18.1, interaction with the software environment of the object structuring system 17 through interaction 0.8 with the H-SC 8 interaction; interactions 0.8 to save information 9 in the software environment for structuring objects 17, including in the blockchain environment 17.1, interactions 0.9 to save the received information 9 in the external software environment 18, including in the blockchain environment 18.1;

H-SC11 transactions performing the stage of forming a transaction and forming a software transaction algorithm, interacting 0.8 with H-SC 8, organizing P2P interaction, executing 0.15 transactions according to the generated software algorithm, interacting 0.8 to save information 9 in the software environment for structuring objects 17, including in the blockchain environment 17.1, interacting 0.9 to save the received information 9 in the external software environment 18, including in the blockchain environment 18.1.

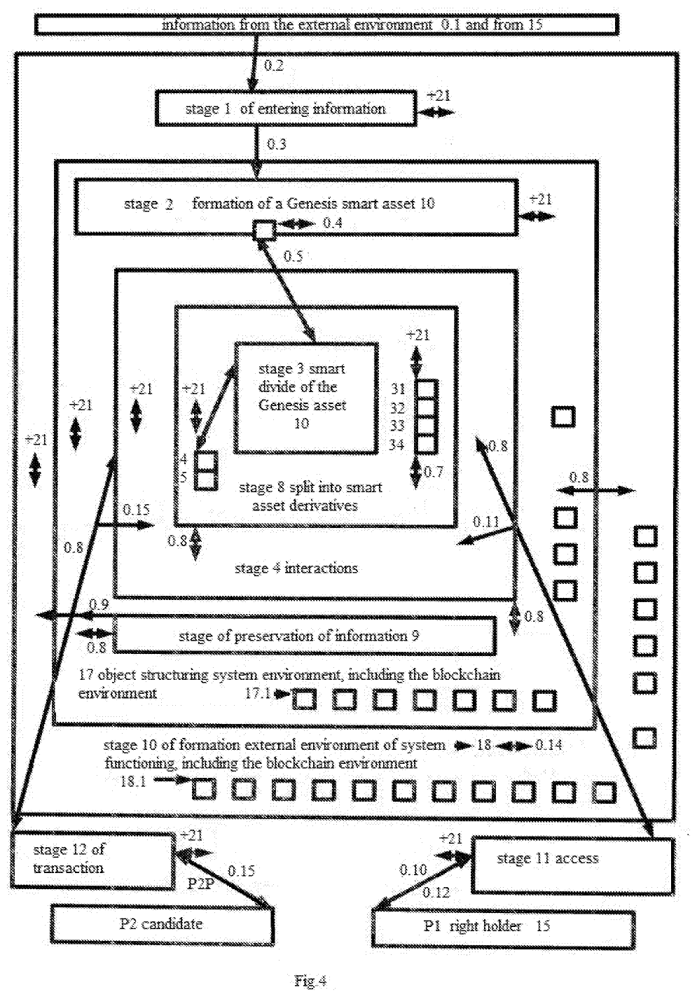

FIG. 4 is a block diagram illustrating the options and stages of the method for structuring objects for functioning in software environments.

With reference to FIG. 4, variants of the method include:

stage 1 entering 0.2 information on 0.1 environment and setting tasks 0.3 for stage 2;

stage 2 formation of 0.4 Genesis smart asset object 10, interactions 0.5 with stage 3;

stage 3, dividing 0.6 of the Genesis smart asset of the object 10 into the smart asset of the right to the object and the smart asset of the object's capital;

stage 8 dividing the smart assets received at stage 3 into derived debit and credit smart assets, respectively; stage 4 interaction of 0.7 smart assets with each other, interaction of 0.8 with the environment of the object structuring system 17, including the blockchain environment 17.1 and with stage 11, interaction 0.9 with the external environment 18, including the blockchain environment 18.1 and with stage 10;

stage 9, storing 0.9 information 9 in the environment of the object structuring system 17, including with the blockchain environment 17.1, interaction 0.8 with stage 4, interaction 0.9 with the external environment 18, including with the blockchain environment 18.1 and with stage 10;

stage 10 of formation 0.14 of the external 18 software environment of functioning, including the blockchain environment 18.1;

stage 11, access 0.11 to stage 4 in the object structuring environment 17 of the registered 0.10 P1 rightholder 15 and interaction 0.12 with the registered 0.10 P1 rightholder 15;

stage 12, transactions 0.15 to and from stage 4, interaction 0.8 with stage 4, organization of P2P interaction; protection stage +21 setting the security program code +21.

### IMPLEMENTATION OF THE INVENTION

Let's look at three examples (brief description): private, subject, and scalable.

Example 1 private: Consider an author's work (picture, software product, etc.), as an object that contains both value and property rights and other non-proprietary rights, copyright. In this example, the object is created by the author who is the copyright holder. The copyright holder is registered in the object structuring system by means of a hardware and software access complex. Rightholder of the object determines and/or provides an assessment of the value and other characteristics of the object, including using a predefined algorithm, specifies the characteristics of the object in predefined units of measurement (these can be any, including tokens, coins, any crypto assets, digital cash, cryptocurrency, etc.). Access is provided to the software environment of the object structuring system, which can be a blockchain environment and/or use a blockchain environment. Then, by means of the software and hardware input complex, the stage of entering information and setting a task for the formation of a Genesis smart asset is carried out. The system of structuring objects by means of software and hardware complexes of the system forms a Genesis smart asset, divides it into derived smart assets that include values specified in predefined units of measurement that function in software environments, implementing an interaction algorithm. The interaction algorithm can provide the transfer of values specified in predefined units of measurement by the copyright holder to the applicant for solving predefined tasks (making investments, generating income, implementing P2P interaction, management, etc.). the algorithm can also perform software interaction with the applicant's smart contract on predefined conditions.

The system structures the object into smart assets for functioning in software environments, creates a Genesis smart asset, which is divided into a smart asset that carries the right to the object and a smart asset that carries the object's capital and derivative smart assets of debit and credit, respectively.

To interact with the external software environment of the applicant, as a security option, use smart assets and values specified in predefined units of measurement that do not have rights to the object.

Alternatively, there may not even be in smart asset the value of the object's capital, but only the signification of the right to the object's capital. This gives protection to the object's capital, its smart asset, and its rightholder, since capital is accrued only if predefined conditions, including software conditions, are met. As a security option, in the program code of a certain smart asset insert a security code that restricts or prohibits interaction with the external software environment.

A more specific description of the further implementation of the invention will be presented later in the text with links to diagrams and figures, since the further implementation is generalized.

The next example. Here the object is a subject—a territorial-administrative entity that has final dimensions in predefined units, which can be converted and expressed in the values specified in the necessary predefined units. In this example, as an implementation variant, the value and other characteristics of the object that have a preliminary assessment can be entered into the object structuring system, including using a predefined algorithm, not only by the object's copyright holder, but also by the system, using predefined programs and input algorithms, including using artificial intelligence. After entering this information into the software and hardware input complex, the object structuring system performs its work in the parameters described in the previous example, taking into account a predefined finite number of copyright holders and a certain completeness of the object. Rights and access keys to the system are transferred to registered and pre-defined object rights holders to exercise their rights to the object. A more specific description of the further implementation of the invention will be presented later in the text with links to diagrams and figures, since the further implementation is generalized.

The example is scalable. The object is not restricted (for example: outer space and everything it includes). There is a dynamic set of copyright holders. Universal law, the universal Commons, prevails here. In this case, the object structuring system works dynamically, thus introducing into the system those parts of the object that have become available and can be shared by everyone. In this example, as an implementation variant, the value and other characteristics of the object that have a preliminary assessment can be entered into the object structuring system, including using a predefined algorithm, not only by the object's copyright holder, but also by the system, using predefined programs and input algorithms, including using artificial intelligence. After entering this information into the hardware and software input complex, the object structuring system performs its work in the parameters described in the previous examples, taking into account the non-predefined, dynamic number of copyright holders and a certain completeness part of objects. Registered and having predefined rights to the object rights holders are given rights and access keys to the system to exercise their rights to the object. The technical solution can be implemented in the form of dynamically distributed artificial intelligence, with a multi-level, dynamic consensus, achieved including using quantum cryptography and reading quantum entanglement. From these examples, we can conclude that this invention is applicable both in private and in a broader application, including for resolving territorial and political problems and conflicts, to achieve a new level of structuring, management and interaction. For to achieve secure governance based on P2P interaction of a fair universe.

More specific embodiments of the present invention will be described with reference to the attached diagrams and drawings. The description of the implementation of the invention is disclosed in the examples, but this does not mean that the variants of the system and method are applicable only to the objects indicated in the examples. The present invention is not limited to the disclosed embodiments and can be implemented in various forms. Objects that have not yet been formed can be structured in the system. The subject can also be represented as an object for the object structuring system.

Due to the fact that the level of technology is changing rapidly and it is impossible to foresee all possible combinations of hardware and software systems, as a basis we take that all hardware and software complexes (H-SC) in the present invention presents a necessary and sufficient prior art and correspond to the time period of their use for the implementation of the present invention. The invention can also use a virtual machine (VM) as a combination of H-SC.

FIGS. 1,2,3,4 show examples of implementation of technical solutions according to the system and methods for implementing the object structuring system for functioning in software environments in which the following steps are performed:

stage 1 of entering 0.2 by means of H-SC 1 information 0.1 from the external environment and setting the task 0.3 H-SC 2;

In this step 1, by means external to the software environment of system structuring objects 17, a hardware-software complex (HSC) input 1 using the algorithm of interaction of 0.2 with the external environment, get 0.2, take 0.2, including from registered 0.10 in the wiring system of objects 17 of the owner of the object 15 which is necessary and sufficient for operation of the system of structuring objects 17 information 0.1, including about the object.

Setting and transmitting set values, including in predefined units of measurement, to the environment of the object structuring system.

Confirmation the statement 0.3 of the task for the formation of the Genesis smart asset of object 10.

Transfer 0.3 of the received information to stage 2 of the Genesis smart asset formation 10 to the software environment of the structuring system objects 17 to the hardware and software complex H-SC 2 for the formation of a Genesis smart asset 10.
stage 2 formation 0.4 Genesis smart asset object 10;

On which by algorithms of hardware-software complex H-SC 2, implement: formation of the Genesis smart asset object 10; receiving/transmiting 0.3 an adapted for software environment system structuring objects information generated in step entering 1 information 0.1 from the external environment. Then forming 0.4 by means of a software algorithm, a machine-readable Genesis smart asset of the object 10, using, among other things, the values specified in predefined units of measurement that characterizes the object and/or smart asset. Transmitted 0.5, information generated by using a software algorithm to the stage 3, of dividing of the Genesis smart asset 10, to the hardware and software complex H-SC 3 of divide of the Genesis smart asset 10. Saving 0.7,0.8 received information 9 in the object structuring software environment 17, saving 0.9 received information 9 in an external software environment 18, including the blockchain environment 17.1 18.1, including consensus building, including using quantum cryptography and reading quantum entanglement.
stage 3 of dividing the Genesis smart asset of object 10;

On which by means of the hardware-software complex H-SC 3 of dividing, received information 0.5 generated at stage 2 of the formation of the Genesis smart asset of object 10, divided 0.6 by means of the software division algorithm of the Genesis smart asset of object 10, at least on the machine-readable smart asset of the right to object 4 and on the machine-readable smart asset of the capital to object 5. Formed by means of a software algorithm a machine-readable smart asset of the right of object 4 and a machine-readable smart asset of the capital of object 5. Fixed of by means of the program code in the smart asset of the right information containing the value code that this smart asset 4 contains an intangible right of the first level arising from the birth of the object or subject.

Also, by means of a software algorithm, in the smart asset of capital 5, information is recorded containing a value code that this smart asset 5 contains a material right to the capital of the object, which arises as a result of dividing the rights to the object through the software algorithm for dividing the genesis smart asset 10 and the introduction into the smart asset of capital 5 of the value characteristic specified in the program code of the smart asset 5 in predefined units of its measurement (this can be any cryptocurrency, digital currency, etc.). By means of a software algorithm, in the smart asset of the right 4 and the smart asset of capital 5, the values indicated in predetermined units of measurement, characterizing each smart asset, are recorded. An algorithm of interaction with other stages is established by means of a pre-installed program. The received information is transferred to stage 8 of the interaction of smart assets. Save 0.7, 0.8 the received information 9 in the object structuring software environment 17. structuring objects 17. Stored 0.9 received information 9 in external software environment 18, including blockchain environment 17.1,18.1, including reaching a predetermined consensus, including using quantum cryptography and reading quantum entanglement.
stage 4 of interaction of smart assets;

On which, through the H-SC 8 hardware and software complex, the interaction of smart assets, they interact according to a preset algorithm between smart assets 10, 4, 5, 6, 7, 19, 20 to receive and/or transmit relevant information from a smart asset or to a smart assets. Included in the preset software algorithm the necessary and sufficient information for the interaction of the corresponding smart asset and/or smart assets with the software algorithm of the external software environment 18, including the blockchain environment 18.1 in accordance with the preset interaction program.

Performed interactions 0.9 with the external software environment 18 by means of a pre-installed interaction algorithm for receiving/transmitting relevant information from the external software environment and/or to the external software environment, including to and from the blockchain environment 18.1, including achieving a predefined consensus, including using a quantum cryptography and quantum entanglement reading. Saved 0.8 received information 9 in the software environment for structuring objects 17, save 0.9 received information in external software environment 18, including in the blockchain environment 17.1,18.1, including with the achievement of a predetermined consensus, including using quantum cryptography and reading quantum entanglement.
stage 8 dividing into divide smart assets;

On which, through the H-SC 3 hardware and software complex division, divide the smart asset of the rights to object 4 and the smart asset of the capital of object 5 into their constituent smart assets of debit 6.19 and credit. 7.20. The +21 program code protects the debit 6.19 smart asset and its interaction algorithm, which carries the absolute value of the right component of the derived smart asset specified in the algorithm in pre-defined units of measurement. Note, Credit smart asset 7.20 and the algorithm of its interaction, bearing the relative value of the right component of the derivative smart asset 4.5, indicated in the algorithm in predetermined units and is marked program code +21 protection. Interact 0.7,0.8, including 0.9 with the external software environment 18 by means of the values of the predefined units of measurement and the software interaction algorithm.
protection stage+21;

On stage the software-installed and software-removable code +21 of protection and blocking +21 is entered into the corresponding smart asset and the software algorithm for its interaction, including

interaction with the external software environment 18, including the blockchain environment 18.1.

Also, in the system and its implementation methods, protection is achieved by executing a predefined consensus, as well as using quantum cryptography and quantum entanglement information reading systems.
stage 10 formation of the external software environment of functioning;

On stage, by means of the hardware and software complex, the HSC 12 environments form 0.14 the external software environment 18 for the functioning of the object structuring system 17,17. 1, including the blockchain environment 18.1. Also, at stage 10 established the interaction of the software environment of the object structuring system 17, 17.1 with the software environment of functioning 18, 18.1, which is external to the software environment of the object structuring system 17,17.1. Also, at stage 10, 0.8 interacts with the HSC 8 of stage 4 and stores 0.8 information 9 at the stage of saving information 9.
access stage 11;

On stage, by means of a hardware-software complex access HSC 14, register 0.10 copyright holder 15 of the object, including as user software algorithm to program access, including to environment structuring system of objects 17, to external environment of functioning of smart assets 18, including to the blockchain environment 17.1,18.1. Also, at stage used transfer the rights and access keys to manage smart assets, including the values specified in these smart assets, to the registered copyright holder of the object. Access 0.11 in HSC 8 to stage 4. Through HSC 8 and stage 4 access to the software environment of the object structuring system 17, including the blockchain environment 17.1, including achieving a predefined consensus, including using quantum cryptography and reading quantum entanglement.
stage 12 transactions;

On stage transactions interact 0.8 with the software and hardware complex HSC 11 of smart asset interaction. Generates 0.15 program algorithm for transactions between software environments, values specified in predefined units in smart assets. Stage 12 performs P2P interaction, execute 0.15 transaction according to the generated software algorithm. Saves 0.8 received information 9 in the object structuring software environment 17,17.1. Saves 0.9 received information 9 in the external software environment 18, including the blockchain environment 18.1, including the achievement of a predetermined consensus, including the use of quantum cryptography and reading quantum entanglement.

### INDUSTRIAL APPLICABILITY

The proposed invention can be implemented by a specialist in practice and have industrial applicability while providing the claimed purpose, which allows us to conclude that the “industrial applicability” criterion for the invention is met. The use of the invention can be carried out in many fields of activity. In accordance with the proposed invention, an experimental system for structuring objects is made. The verification of its implementation system and the implementation of the method of structuring objects for functioning in software environments was carried out. Tests of the pilot system have shown that it provides the ability:
structure objects into smart assets and their program codes for working in software environments, using the values specified in the predefined units of measurement of the object and smart asset;
function and interact with smart assets and their program codes in software environments, including the blockchain environment;
organize control objects;
organize structural P2P interactions.

The use of this invention in the production sphere allows you to repeatedly increase the security and reduce the vulnerability of working software elements existing in software environments, by entering a system and a method for structuring objects for functioning in software environments that allow you to perform the above functions.

The novelty of this invention in the field of organizing virtual space, managing the operation of virtual space, organizing the interaction of virtual and real spaces, and functioning of various objects in software environments is:
organization of object structuring and formation of a Genesis smart asset, its smart division into derivative smart assets, including a smart asset containing information that this smart asset bears an intangible right of the first level arising from the birth of the object or subject;
smart asset of capital containing information that this smart asset bears a material right to the capital of the object, which arises as a result of smart division of rights to the object by means of a software algorithm for dividing the Genesis smart asset and introducing characteristic of capital into the smart asset, including a value characteristic;
smart asset of debit with its protection by the program code of its interaction algorithm and the absolute value of the component of the parent smart asset's rights, indicated in the algorithm in predefined units of measurement;
smart asset of credit with a mark in the code of its interaction algorithm that carries the relative value of the parent smart asset's original right component, indicated in the algorithm in predefined units of measurement, organization of interaction of smart assets with each other, as well as organization of their interaction with the external environment, including the blockchain environment, including achieving a predefined consensus, including using quantum cryptography and reading quantum entanglement.

This is achieved, among other things, through the interaction of control programs that include either a full set of processing of all smart assets and their information blocks, or only those that are necessary to solve the tasks set. The system was based on the principle of multi-value smart asset. Using the present invention are shown below, using the example of the code to understand how it works, its industrial applicability, the understanding by person skilled in the art, but not an exact copy, as should be observed the principles of protection of software code and know-how. The example is represented by a fragment of program code in the solidity programming language:

pragma solidity \hat{ }0.4.0;
genesis BaseActiv {

mapping(address =>uint) public balance;
FirstActiv first;
SecondActiv second;
function BaseActiv(string firstData,string secondData){

first=FirstActiv(firstData);
second=SecondActiv(secondData);

}
function recive(uint amount){

balance [msg.sender]+=amount;
first.balance[msg.sender]+=amount;
second.balance[msg.sender]+=amount;

}
function send(addrese to,uint amount){

if(balance[msg.sender]<amount

first.balance[msg.sender]<amount
second.balance[msg.sender]<amount

) return;
balance[msg.sender]−=amount;
first.balance [msg.sender]−=amount;
second.balance[msg.sender]−=amount;
balance[to]+=amount;
first.balance[to]+=amount;
second.balance[to]+=amount;

}
function sendFirst(addresee to,uint amount){

if(first.balance[msg.sender]<amount) return;
first.balance[msg.sender]−=amount;

first.balance[to]+=amount;

}
function sendSecond(addresee to,uint amount){

if(second.balance[msg.sender]<amount) return;

second.balance[msg.sender]−=amount;
second.balance[to]+=amount;}

}
contract FirstActiv{

string data;
mapping(address =>uint) public balance;
function FirstActiv(string _data){

data=_data;

}

}
contract SecondActv{

string data;
mapping(address =>uint) public balance;
function SecondActiv(string _data){
data=_data;
}

A specialist in this field of technology can easily understand other versions of the invention from the description considered. This application is intended to cover any use or application of the following General principles of the invention, including such deviations from the present invention as appear within the limits of known or common practice in the state of the art. It is assumed that the description is considered only as an example, with the essence and scope of the present invention indicated by the claim. It should be taken into account that the present invention is not limited to the exact designs and names of smart assets that have been described above and illustrated in the attached drawings, and that various modifications and changes can be made without departing from the scope of its application. The study by the author from available sources, including the patent offices of USA, Japan, South Korea, China, European patent office, Eurasian patent office, information from the prior art, enables to conclude that the invention meets the criteria of novelty, inventive step, practical applicability.

1. Object structuring system for functioning in software environments contain:
hardware-software complex for implementing and setting a task, made with the ability to:
interaction with the external software environment through a predefined software algorithm;
input, reception, processing, adaptation, synchronization with the software environment of the object structuring system, including information received from the object's right holder registered in the system, including information about the object that is necessary and sufficient for the system to function;
setting the task of forming the Genesis smart asset of the object;
transfer of the received information to the software environment of the object structuring system to the hardware and software complex for generating a Genesis smart asset;
hardware-software complex for generating the Genesis smart asset of an object, made with the ability to:
receive information adapted for the software environment of the object structuring system from the hardware and software input complex;
generation of a machine-readable Genesis smart-asset using an algorithm that among others, uses the values specified in predefined units of measurement, characterizing the object and smart asset;
transfer the received information to the hardware and software complex of smart divide of the Genesis smart-asset;
save the received information in the object structuring software environment, including the blockchain environment;
save the received information in an external software environment, including the external blockchain environment;
hardware-software complex smart divide, made with the ability to:
receive information from hardware-software complex for generating a Genesis smart asset;
divide the Genesis smart asset of the object by a software algorithm into at least a machine-readable smart asset of the right to the object and a machine-readable smart asset of the object's capital;
fix by means of a software algorithm in the smart asset of the right, information indicating this smart asset bears an intangible right of the first level, occurring from the object or subject making;
fix, by means of a software algorithm, in the smart-asset of capital, information indicating this smart-asset bears a material right to the capital of the object, right as a result of the rights' division to an object in the software algorithm for dividing the Genesis smart asset and introducing a value characteristic of smart asset capital;
fix in the smart asset of rights and in the smart asset of capital, values specified in predefined units of measurement characterizing each smart asset;
save the received information in the object structuring environment, including the blockchain environment, also the environment with the achievement of a predetermined consensus, using quantum cryptography and reading quantum entanglement;
save the received information in an external software environment, including a blockchain environment, with the achievement of a predetermined consensus, using quantum cryptography and reading quantum entanglement;
hardware-software complex for smart-assets interaction, designed with the ability to:
interaction with the smart asset and/or smart assets to receive and/or transmit relevant information from or to the smart asset;
including in the pre-installed software algorithm the necessary and sufficient information for interaction of the corresponding smart asset and/or smart assets with the software algorithm of the external environment in accordance with the pre-installed interaction program;
interaction with the external software environment through a pre-installed interaction algorithm for receiving and/or transmitting relevant information from the external software environment and/or to the external software environment, including to and/or from the blockchain environment, including achieving a predefined consensus, including using quantum cryptography and reading quantum entanglement.

2. A method for structuring objects for software environment, implemented in the system according to claim 1, contains:
the stage of implementing information from the external environment and setting the problem, which, by means of a system for structuring objects, the hardware and software complex for implementing and setting the problem uses an algorithm for interacting with the external environment:
receive and accept, including from the rightholder of the object, registered in the object structuring system, information necessary and sufficient for the functioning of the object structuring system, also about the object;
specify and transmit values set, including predefined units of measurement, to the environment of the object structuring system;
confirm the task statement for the formation of the Genesis smart asset of the object;
transfer the received information to the stage of Genesis smart asset formation in the software environment of the object structuring system to the hardware-software complex for Genesis smart asset formation;
the stage of forming the Genesis smart asset of an object, where the algorithms of the software and hardware complex for forming the Genesis smart asset of an object are used:
receive and accept information adapted for the software environment of the object structuring system, formed at the stage of entering information from the external environment;
form a machine-readable Genesis smart asset of an object using a software algorithm, and use, among other things, the values specified in predefined units of measurement characterizing the object and the smart asset;
transfer the information generated by using a software algorithm to the stage of smart division of the Genesis smart asset to the hardware-software division complex of the Genesis smart asset;
save the received information in the object structuring software environment;
save the received information in an external software environment, including the blockchain environment, also achieving a predefined consensus, using quantum cryptography and reading quantum entanglement;
the stage of smart divide of the Genesis smart asset of an object, on which the smart division hardware and software complex is used:
accept information generated at the stage of forming the Genesis smart asset of an object;
divide the Genesis smart asset of the object by a software division algorithm, at least into a machine-readable smart asset of the right to the object and a machine-readable smart asset of the object's capital;
form by means of a software algorithm a machine-readable smart asset of the right to the object and a machine-readable smart asset of the object's capital;
fix by means of the program code in the smart asset of the right, information that this smart asset bears an intangible right of the first level, arising from the birth of the object or subject;
fix through a software algorithm, in the smart-asset of capital, information indicating that this smart-asset bears a material right to the capital of the object, right arises as a resulting from the division of rights to an object in the software algorithm for dividing the Genesis smart asset and introducing a value characteristic in smart asset of capital;
fix by means of a software algorithm in the smart asset of rights and the smart asset of capital, the values specified in predefined units of measurement that characterize each smart asset, respectively;
install an algorithm for interacting with other stages using a pre-installed program, and transmit the received information to the smart asset interaction stage;
save the received information in the object structuring software environment;
save the received information in an external software environment, including the blockchain environment, including achieving a predefined consensus, including using quantum cryptography and reading quantum entanglement;
the stage in the cooperation between smart assets, which by means of a hardware-software complex interaction smart assets carry out:
interaction using a pre-defined algorithm between smart assets for receiving and/or transmitting relevant information from or to a smart asset;
include necessary and sufficient information in pre-installed software algorithm to use the appropriate smart asset and/or smart assets software algorithm external software environment in accordance with a preinstalled program interaction,
include the necessary and sufficient information in the pre-installed software algorithm for the interaction of the corresponding smart asset and/or smart assets with the software algorithm of the external software environment, in accordance with the preset interaction program;
interaction with the external software environment by means of a pre-set interaction algorithm for receiving and/or transmitting relevant information from the external software environment and/or to the external software environment, including to and from the blockchain environment, including achieving a predefined consensus, including using quantum cryptography and reading quantum entanglement;
save the received information in the object structuring software environment, saving the received information in the external software environment, including the blockchain environment, the environment with the achievement of a predefined consensus, using quantum cryptography and reading quantum entanglement.

3. According to claim 1, the system differs with components:
hardware-software complex, configured to form an external software environment for functioning a system of structuring facilities, including the blockchain environment, achievement of predefined consensus, with the use of quantum cryptography and quantum entanglement read;
hardware-software access complex, made with the ability to:
registration of the rightholder of an object, including as a user by a software algorithm-access program, including in the environment of the object structuring system, the external environment for the functioning of smart assets, including the blockchain environment;
transfer of rights and access keys to manage smart assets, including the values specified in these smart assets, to the registered owner of the object;
access to the software environment of the object structuring system, including the blockchain environment, including the environment with the achievement of a predetermined consensus, including using quantum cryptography and reading quantum entanglement;
hardware-software complex for forming a transaction, made with the ability to:
interaction with the hardware-software complex of smart asset interaction;
formation of a software algorithm transaction;
implementation of P2P interaction;
implementation of the transaction according to the generated software algorithm;
saving the received information in the software environment for structuring objects, including in the blockchain environment;
storing the received information in an external software environment, including in the blockchain environment, including in the achieving a predefined consensus, including using quantum cryptography and reading quantum entanglement,
while hardware and software complex smart-fission by means of a software algorithm divides the smart asset of the right to object and smart asset capital of the object into its component: smart-asset of the debit and smart-asset of the credit, when the debit smart asset protects by the program code the absolute value component of the right contained in the corresponding smart asset, indicated in the algorithm in predefined units of measurement, and smart asset of the credit carries a relative value component of the right contained in the relevant smart asset identified in the algorithm of smart asset of the credit in the predefined units of measurement, by which, in particular, interact in an external program environment, at the same time, in any smart asset includes in the program algorithm a programmatically installed and programmatically removed lock code from interacting with the external software environment.
